(19) United States
(12) Patent Application Publication
(10) Pub. No.: US 2015/0084328 A1
(43) Pub. Date: Mar. 26, 2015

(54) COMPENSATOR ARRANGEMENT

(71) Applicant: WITZENMANN GMBH, Pforzheim (DE)

(72) Inventors: Andreas Kampfe, Pforzheim (DE); Bert Balmer, Pforzheim (DE); Peter Rittershofer, Pforzheim (DE); Frank Thome, Ispringen (DE); Matthias Weber, Bretten (DE); Harald Betke, Pfrozheim (DE)

(73) Assignee: WITZENMANN GMBH, Pfrozheim (DE)

(21) Appl. No.: 14/494,683

(22) Filed: Sep. 24, 2014

Related U.S. Application Data
(60) Provisional application No. 61/881,631, filed on Sep. 24, 2013.

(51) Int. Cl. F16L 27/11; F16L 59/14

(52) U.S. Cl. CPC F16L 27/11; F16L 59/14
USPC 285/48; 285/226; 285/227

(57) ABSTRACT

A compensator assembly, including a metal bellows (2) with a weld end or connecting end (3, 4) in each case on both sides, at least one single-part or multipart guide tube (11), two support rings (5, 6), of which one is connected to a weld end (3, 4) in each case, and an anchoring box (7), which is supported on end faces (5a, 6a) of the support rings (5, 6) facing away from the metal bellows (2), wherein the support rings (5, 6), on the end face (5a, 6a) facing away from the metal bellows (2), have support elements (16) projecting in a direction of the anchoring box (7), and/or the anchoring box (7), on an end face (8a, 9a) facing the respective support ring (5, 6), has support elements (16) projecting in a direction of the support ring (5, 6).

### INCORPORATION BY REFERENCE

The following documents are incorporated herein by reference as if fully set forth: U.S. Provisional Appln No. 61/881,631, filed Sep. 24, 2013.

### BACKGROUND

The invention relates to a compensator arrangement with a metal bellows and an anchoring frame.

In order to minimize the heat losses in high-temperature pipes, such pipes are usually provided with a thermal insulation.

In compensators, which are provided for expansion compensation in such pipes, the metal bellows is produced either from a high temperature-resistant material and is located inside said insulation, or its operating temperature has to be reduced by means of insulation measures in relation to the temperature of the medium. This can be carried out for example by means of particularly long and/or flared weld ends and by means of an insulation between the guide tube and the weld end.

Via an anchoring, the metal bellows is relieved of the pressure reaction forces. The anchoring in the case of high-temperature compensators usually consists of anchoring boxes, mounted in a floating manner on the weld ends, and tie rods fastened thereupon. The anchoring boxes are supported on support rings which are fixed connected to the weld ends. Since the anchorings as a rule are not insulated, these can act like a large heat dissipater and consequently lower the temperature of the metal bellows.

Consequently, the temperature difference between the pipe and the metal bellows is increased further. This temperature difference has to be compensated over the length of the weld end, which leads to different thermal expansions and, as a result, to high mechanical loads of the weld ends. In addition, the weld ends of the metal bellows are loaded to a varying degree in sections as a result of the anchoring forces. As a result of the superimposition of the thermal and mechanical stresses, local stress points are created and often limit the operating time of the compensators to less than 100 complete thermal cycles. A breakdown of the weld ends is usually a cause of failure.

### SUMMARY

The requirement is therefore for a compensator with an anchoring box, which on the one hand is thermally better insulated from the weld end of the metal bellows and which on the other hand introduces the anchoring forces into the weld end as uniformly as possible. As a result, the thermally induced stresses are reduced and the mechanically induced stresses are distributed more uniformly in the weld end so that a longer service life is achieved.

This object is achieved by means of the compensator assembly, the support ring, and/or the anchoring box having one or more features of the invention. Further embodiments of the invention are described below and in the claims. These can be combined with each other in a technologically practical manner. The description, especially in conjunction with the drawing, additionally characterizes and specifies the invention.

One aspect of the invention relates to a compensator assembly, comprising at least one metal bellows, with a connecting end or weld end in each case on both sides; at least one single-part or multi-part guide tube; two support rings, of which one in each case is connected to a weld end; and an anchoring box, which is supported on end faces of the support rings facing away from the metal bellows, wherein the support rings, on the end face facing away from the metal bellows, have support elements projecting in the direction of the anchoring box, and/or the anchoring box, on an end face facing the respective support ring, has support elements projecting in the direction of the support ring.

The compensator assembly can be designed as a so-called angular compensator or as a so-called lateral compensator. In the latter case, the assembly preferably comprises two metal bellows which are arranged in series in the longitudinal direction of the assembly.

The metal bellows is a compensating element which can accommodate transverse displacements or angular movements. By means of a suitable arrangement of such compensating elements, thermal expansions in piping systems can be compensated. The guide tube serves for flow guiding and internal insulation. It preferably consists of at least two tube segments in order to enable an angular or transverse displacement.

The weld ends connect the bellows to the piping system. Due to a preferred increase of the diameter of the weld ends towards the bellows, an annular space is created between the guide tube and the weld end. As a result of the insulating effect of this annular space, which can also be filled with an insulating substance, the bellows temperature is lowered in relation to the pipe temperature.

The support rings can encompass the respective weld ends to their full extent and can be fixedly connected to the weld end. This connection can be a welded connection, for example. The weld end and the support ring can be produced from one material or from different materials, wherein in the case of the production from different materials both materials should have the same or similar thermal expansion coefficients in order to prevent a separation of the connection of the support ring from the weld end as a result of different thermal expansions.

The anchoring box is formed of at least two frames, which are pushed onto the weld ends on both sides of the metal bellows or can subsequently be positioned around the weld ends, and a plurality of tie rods or anchors.

The frames can especially be of circular design and of rectangular or U-shaped design in cross section, with an inside radius which corresponds essentially to the outside radius of the weld end directly next to the support ring on the side pointing away from the metal bellows.

The anchoring box can be formed of two rings, for example, which are pushed onto the weld ends and by means of the anchors are connected in the longitudinal direction of the assembly across the bellows. Alternatively, the anchoring box can be formed of two halves, wherein each half comprises two semi-circular frame sections, for example, which by means of the anchors or a telescopically extendable and retractable spacer are kept at a distance for assembly so that the two frame sections in addition to the support rings can be slipped over the weld ends from the top or bottom or from the sides on the side pointing away from the metal bellows and can be screwed to each other via connecting plates, for example.

The two circular frames or the two frame halves can be of a mirror-image construction or especially of identical construction.

The support ring, on its side pointing away from the metal bellows, and/or the anchoring box, on its side facing the support ring, has support elements which in the direction of the anchoring box or the support ring project at least essentially perpendicularly from the surface of the end face of the support ring and/or of the anchoring box.

The support elements prevent the anchoring box from butting flat against the support ring. This has the effect of limiting the contact of the two parts on the contact face of the support elements. That is to say, forces and heat can be transferred from the support ring onto the anchoring box only via the support elements, and vice versa.

In particular, the transfer of heat between the support ring and the anchoring box can consequently be significantly reduced to a value of 20%, 10%, 5% or less of the heat transfer which would take place in the case of a full-surface contact between the support ring and the anchoring box, depending on the value of the added-up contact faces of all the support elements. As a result, the anchoring box is heated less intensely and instead the temperature of the metal bellows can increase, as a result of which the temperature difference in the weld end is reduced, which leads to less loads (stresses) as a result of different temperatures and therefore to a longer service life or number of complete cycles of the failure-critical weld end. As a result, a service life of the anchoring box can be increased and an operating time for the compensators can be altogether extended.

In addition, the support elements in a suitable arrangement can counteract the anticipated deformation of the anchoring box during operation and can constitute a type of deformation compensation. Consequently, the mechanically induced stresses are distributed more uniformly in the weld end, which leads to a further increase of the service life.

To this end, the support elements can be attached symmetrically to two planes, specifically a first symmetry plane, which is spanned by the center longitudinal axis of the compensator assembly and also by the center of two tie rods which are oppositely disposed with regard to the center longitudinal axis, and a second symmetry plane which also includes the center axis of the compensator assembly and is perpendicular to the first symmetry plane.

The support elements can be separate parts which are connected, or can be connected, to the support ring and/or to the anchoring box. Alternatively, the support elements can be formed in one piece together with the support ring and/or anchoring box or machined out from these.

The size of the support elements or the face of the support element which comes into contact with the support ring or with the anchoring box is smaller by a multiple than the contact face in the case of a flat contact. It can be smaller than the overall possible contact face by the factor of 10 or 20 or more.

The support elements can have a uniform thickness over their length and width, or a foot region of the support elements, which is connected, or can be connected, to the support ring or to the anchoring box, can have a greater width than the face of the support element which comes into contact with the support ring or with the anchoring box. The support elements can also be designed in the shape of a truncated pyramid, a truncated cone, a semi-sphere, etc.

The length of the support elements, measured in the longitudinal direction of the compensator assembly, can basically be freely selected by the person skilled in the art. The length of the support elements is the length by which the support elements project from the surface of the end face of the support ring or of the anchoring box.

The support elements can comprise a thermally insulating material or can be formed from a thermally insulating material and have a high strength. That is to say that the support elements can have, for example, a thermally insulating coating or consist of at least two parts, of which one is formed from the insulating material. In this case, the part with the insulating material can, for example, butt directly against the support ring or against the anchoring box or can form a front region of the support element which butts against the anchoring box or against the support ring. Additionally or alternatively, the support face or end face of the support element can formed with an arched shape or corrugated shape, as a result of which the contact face between the support ring and the anchoring box is further reduced.

The support elements, on the end face, can be arranged in a uniformly distributed manner over the circumference of the support ring and/or of the anchoring box, that is to say can have a uniform angular distance from each other. The angular distance can be 180° in the case of two support elements, 90° in the case of four support elements, 45° in the case of eight support elements, etc.

In this case, it can be advantageous to design the two support elements to be longer than, for example, the eight support elements. It is furthermore possible to design specific support elements to be longer and/or thicker than others. Also as a result of this, a compensating action with respect to deformations can be achieved.

An intermediate space, which is created by the support elements, between the support ring and the anchoring box can be filled or are filled with a thermally insulating material. This can be a ring-like component, for example, which is inserted into the gap, which is defined by the support elements, between the support ring and the anchoring box, or can be an insulating mat or a high temperature-resistant insulating foam or a ceramic element, etc.

The anchoring box can have a plurality of tie rods which are arranged uniformly over the circumference of the anchoring box. If only one of the frames has the tie rods, the other frame has to have corresponding complementary anchoring points or anchoring elements for the tie rods.

The tie rods can advantageously be designed as pairs of two flat anchors which are preferably designed to be approximately of equal length and be interconnected via one or more joints.

The tie rods can extend from one frame of the anchoring box in the direction of the other frame or of the anchoring box halves and can, for example, be interconnected via the metal bellows so that the two frames of the anchoring box are pressed by an end face, or by the support elements which project from the end face, tightly against the end face, or against the support elements of the support ring which project from the end face.

The tie rods, or a center longitudinal axis of each tie rod, can extend essentially parallel to a center longitudinal axis of the compensator assembly at least in the anchored or connected state.

The anchoring box can have, for example, altogether two or four tie rods which are connected to the anchoring box at an angular distance of 180° or 90°. Two of the tie rods in each case can then lie opposite with regard to a plane through the center longitudinal line of the compensators.

The tie rods can especially be of a bar-like form, having a flat upper side and lower side which lie in parallel planes which are perpendicular to a plane which is spanned by the center longitudinal axes of the compensator assembly and of the tie rod. This prevents the occurrence of additional twisting forces when the tie rods are put under tension and/or compression.

Each of the support elements can be arranged between two adjacent tie rods and have an equal angular distance from each of the two tie rods. That is to say that four support elements can have an angular distance of 90° from each other and that each of the support elements has an angular distance of 45° from two adjacent tie rods. This always applies when the number of the support elements is equal to the number of tie rods. This rule is correspondingly applicable if the number of support elements is larger or smaller than the number of tie rods. The invention is not limited to such angular distances, however.

It is particularly advantageous if exactly twice as many support elements as tie rods are used. This leads to minimal mechanical loads during operation of the compensator on account of local stress peaks as a result of the anchoring forces in the weld ends, which in turn can have a favorable effect upon their service life or upon the period of application of the compensator assembly.

No support elements are preferably arranged directly beneath the tie rods so that the anchoring box can deform in this region in the direction of the center longitudinal axis of the compensator assembly.

A further aspect of the invention relates to a support ring for a compensator assembly. The support ring has support elements on at least one end face which project essentially perpendicularly from the end face of the support ring.

The support ring can especially be the support ring for a metal bellows of a compensator assembly, as has already been described in detail further above.

A further aspect of the invention relates to an anchoring box which comprises two especially identical frames or frame sections, wherein each of the frames has a plurality of tie rods and support elements on at least one end face of the frame. The support elements project essentially perpendicularly from the end face of the frame.

The anchoring box can especially be the anchoring box of a compensator assembly, as has already been described in detail further above.

Applicable to the overall description and to the claims is that the term “a” is used as the indefinite article and does not limit the number of parts to a single part. If “a” should have the meaning of “only one”, then for the person skilled in the art this is to be understood from the context or is made clearly apparent by the use of suitable terms such “a single”.

### BRIEF DESCRIPTION OF THE DRAWINGS

An embodiment of the compensator assembly is explained in more detail in the following text with reference to figures. Technical features which are essential for the invention and which can be gathered from the figures, are part of the scope of the invention and can advantageously develop the invention on their own or in the featured combination.

FIG. 1 shows a compensator assembly according to the prior art;

FIG. 2 shows an anchoring frame according to one aspect of the invention;

FIG. 3 shows a compensator assembly according to the invention in the style of an angular compensator; and

FIG. 4 shows a compensator assembly according to the invention in the style of a lateral compensator.

### DETAILED DESCRIPTION OF THE PREFERRED EMBODIMENTS

In the figures, the same components, or components acting functionally in the same way, are provided with the same designations.

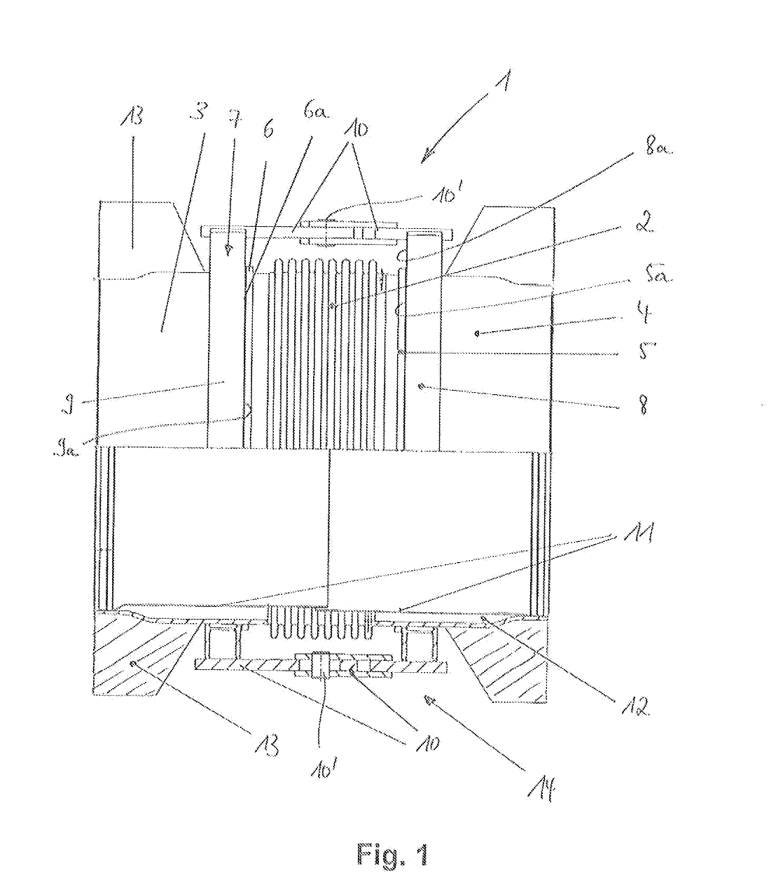

FIG. 1 shows a compensator assembly 1 according to the prior art.

The compensator assembly 1 has a metal bellows 2 with two slightly flared, cylindrical weld ends or connecting ends 3, 4, two support rings 5, 6, a guide tube 11 and an anchoring box 7 with two frames 8,9 and tie rods 10, which tie rods are pivotably connected at 10′ in order to accommodate angular movements.

An insulating material 12 is introduced between the guide tube 11 and the respective weld end 3, 4. The compensator assembly 1 furthermore has an outer insulation 13 with breaks 14 in the region of the tie rods 10.

The anchoring box 7 or the two frames 8, 9 butt by an end face 8a, 9a against an end face 5a, 6a of the support rings 5, 6 with full-surface contact.

A heat flux can be dissipated to the environment via the support rings 5, 6 and the frames 8, 9 of the anchoring box 7 via the tie rods 10.

This leads to cooling of the weld ends 3, 4 during operation and consequently leads to radial thermal expansions of different magnitudes in the weld ends which have to be compensated by elastic or plastic expansions of the material. This results in thermal expansions of the material of the weld ends 3, 4.

In addition to the thermally induced stresses, mechanical stresses occur as a result of anchoring forces. The tie rods 10 of the compensator assembly 1 have an angular spacing of 180°. Deformations of the anchoring box 7 under load lead to a non-rotationally symmetrical introduction of the anchoring forces into the compensator assembly 1 so that local stress peaks can be created.

As a result of this combined load, the weld ends 3, 4 become failure-critical components of the compensator assembly 1 and can often tolerate only less than 100 complete temperature cycles.

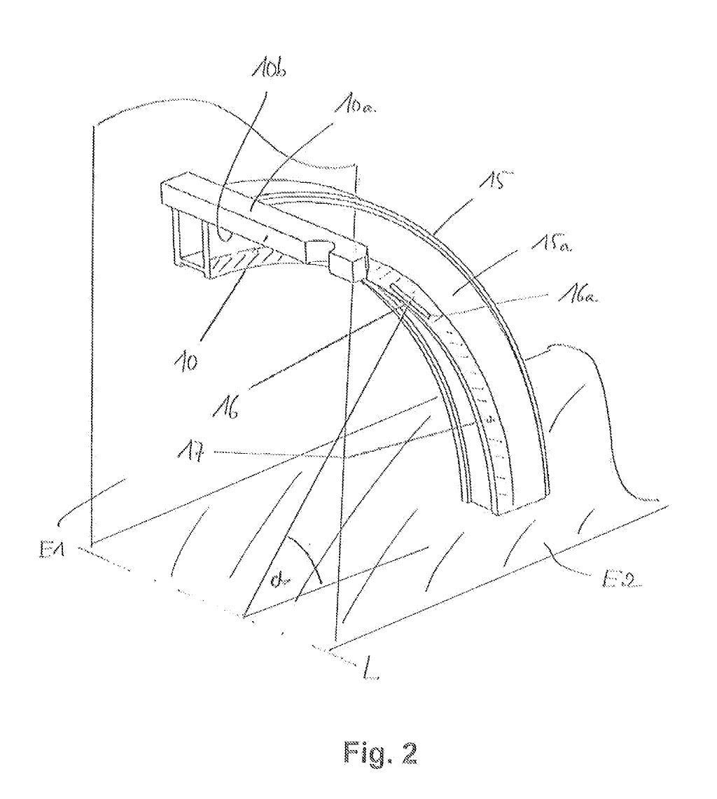

FIG. 2 shows a quarter of a frame 15 which is part of an anchoring box 7 of a compensator assembly 1 according to one aspect of the invention.

The frame 15, or the depicted quarter of the frame 15, has a tie rod 10 and a support element 16 which is connected to an end face 15a of the frame 15 and projects from this. The complete anchoring box 7—not shown—comprises eight such quarters, of which four form one of the two frames 8, 9 in each case, with four tie rods 10 and four support elements 16 per frame 8, 9 in each case in the exemplary embodiment.

Shown on the end face 15a, as a hatched area, is a contact face 17 with which the frame 15 would butt against a support ring 5, 6—not shown—of the compensator assembly 1 if the end face 15a were to have a smooth surface (cf. the prior art according to FIG. 1).

According to the exemplary embodiment shown in FIG. 2, the support element 16, or its end face 16a, forms the contact face with which the anchoring box 7 makes contact with the support ring 5, 6. As a result, the contact face the between support ring 5, 6 and the anchoring box 7 can be reduced to a value of below 5% compared with the flat abutment (designation 17), as a result of which a heat flux is correspondingly also reduced via the anchoring box 7 and especially via the non-insulated anchor 10.

The tie rod 10 is of bar-like design and has a flat upper side 10a and a flat lower side 10b which lie in parallel planes which are oriented perpendicularly to a plane E1 which is spanned by a center longitudinal line L of the compensator assembly 1 and a center longitudinal axis of the respective tie rod 10 which extends parallel to the center longitudinal axis L of the compensator assembly 1. The tie rod 10, in the finished compensator, is connected via a joint arrangement (not shown here; cf. FIG. 1) to another tie rod, which is not shown.

The support element 16 is arranged on the frame 15 symmetrically to the plane E1 and symmetrically to a further plane E2 which includes the center longitudinal axis L of the compensator assembly 1 and is perpendicular to the plane E1, and has an angular distance of α=45° from each of the planes. If a plurality of support elements 16 are provided in the angular region between the two planes E1, E2, those support elements which are arranged closer to the tie rods 10 can be of longer design, that is to say project further in relation to the frame 15 than the support elements which are further away in order to compensate for deformations which occur close to the anchor.

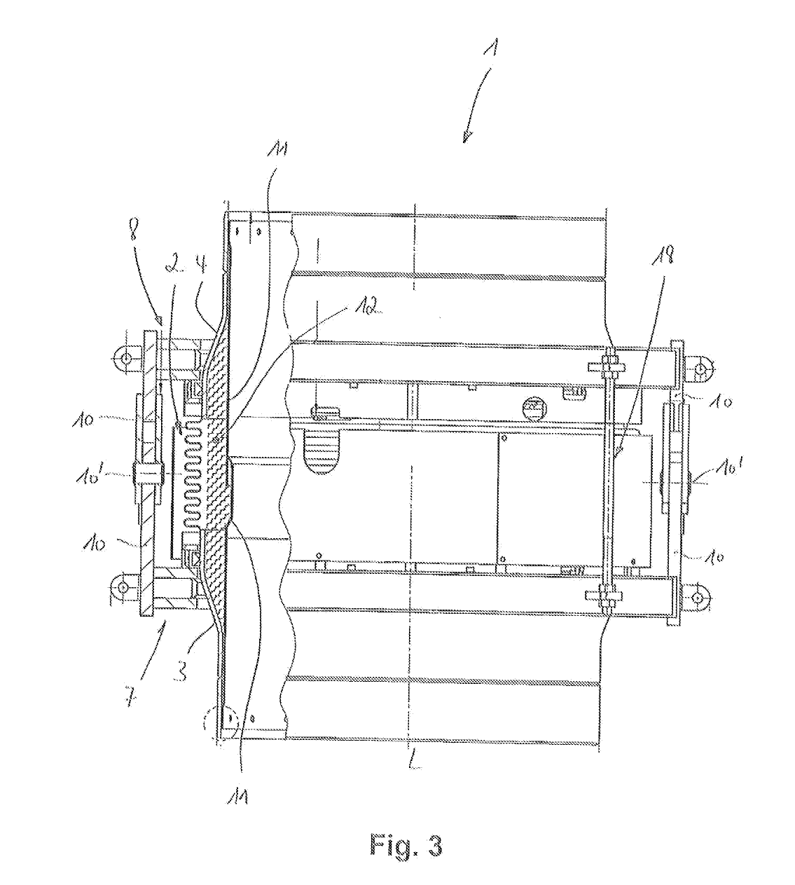

FIG. 3 shows a compensator assembly 1 according to the present invention, partially in longitudinal section, wherein the compensator assembly 1 basically corresponds to the assembly described in detail with reference to FIG. 1—with the exception that the support between the weld ends 3, 4 and the anchoring box 7 is designed according to FIG. 2 or in a comparable way according to the invention.

The compensator assembly 1 according to FIG. 3 has only a single metal bellows 2 and therefore functions as a so-called angular compensator for accommodating angular movements. Additionally shown at 18 is a securing device for transportation which is to be removed before putting the compensator assembly 1 into operation.

Differing from the view in FIG. 1, the compensator assembly 1 according to FIG. 3 does not have outer insulation. This as a rule is only applied afterwards, that is to say after installation of the actual compensator assembly 1 and does not normally fall within the actual scope of supply of the compensator assembly 1.

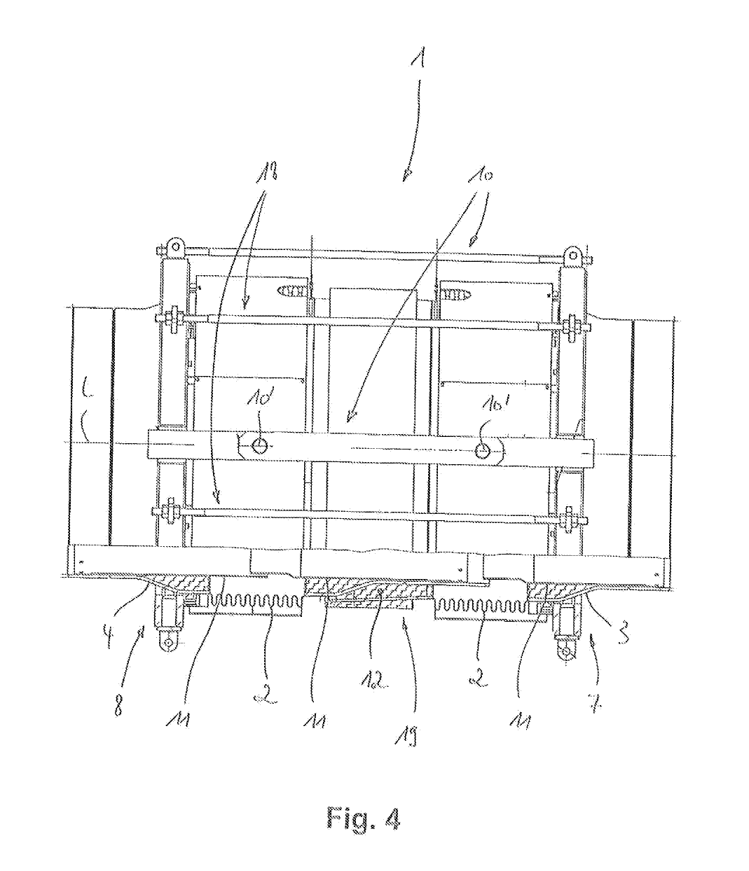

FIG. 4 shows an alternative embodiment of the compensator assembly 1 according to the invention, which has two metal bellows 2 which are arranged in series in the longitudinal direction of the assembly and therefore functions as a so-called lateral compensator, as a result of which lateral displacement movements of a guide assembly, into which the compensator assembly 1 is integrated, can be accommodated. Shown at 18 are again securing devices for transportation which are removed before putting the compensator assembly 1 into operation.

In the case of the embodiment according to FIG. 4, the tie rods/anchors 10 bridge the entire compensator assembly 1, that is to say bridge both metal bellows 2 and also a connecting piece 19 located between them. It is therefore not simply a series-connection of two compensator assemblies 1 according to FIG. 3.

The supporting of the weld ends 3, 4 is also carried out in FIG. 4 according to FIG. 2 or in a comparable way according to the invention.

Otherwise, the same designations refer to the same or functionally the same elements in all the figures.

Although several possible embodiments of the invention have been disclosed in the preceding description, it is understood that numerous further variants of embodiments exist as a result of combination possibilities of all stated technical features and embodiments and also of all technical features and embodiments which are obvious to the person skilled in the art. It is also understood that the exemplary embodiments are to be understood purely as examples which in no way limit the extent of protection, the applicability and the configuration. Rather, the preceding description should be able to demonstrate to the person skilled in the art a suitable way in order to realize at least one exemplary embodiment. It is understood that in an exemplary embodiment numerous modifications with regard to function and arrangement of the elements can be undertaken without departing from the scope of protection and its equivalents which are disclosed in the claims.

For example, the support elements can additionally or alternatively also be arranged on the support ring (cf. FIG. 1).

### LIST OF DESIGNATIONS

1 Compensator assembly
2 Metal bellows
3 Weld end
4 Weld end
5 Support ring
5a End face
6 Support ring
6a End face
7 Anchoring box
8 Frame
8a End face
9 Frame
9a End face
10 Tie rod
10′ Joint
10a Upper side
10b Lower side
11 Guide tube
12 Insulation
13 Outer insulation
14 Break
15 Frame
15a End face
16 Support element
16a End face
17 Contact face
18 Securing device for transportation
19 Connecting piece
E1 Plane
E2 Plane
L Center longitudinal axis
α Angle

1. A compensator assembly, comprising:
at least one metal bellows (2), with a cylindrical connecting end (3, 4) on each side,
at least one single-part or multipart guide tube (11),
two support rings (5, 6), of which one is connected to each of the connecting ends (3, 4), each of the support rings includes an end face (5a, 6a) that faces away from the at least one metal bellows (2), and
an anchoring box (7), which is supported on end faces (5a, 6a) of the support rings (5, 6) facing away from the metal bellows (2),
the support rings (5, 6), on the end face (5a, 6a) facing away from the metal bellows (2), have support elements (16) projecting in a direction of the anchoring box (7), the anchoring box (7), on an end face (8a, 9a) thereof facing the respective support ring (5, 6), has the support elements (16) projecting in a direction of the support ring (5, 6), or both the support rings and the anchoring box include the support elements (16).

2. The compensator assembly as claimed in claim 1, wherein there are two of the bellows (2) which are arranged in series in a longitudinal direction of the assembly and a common connecting piece (19) is arranged between the bellows.

3. The compensator assembly as claimed in claim 1, wherein the support elements (16) transfer at least one of forces or heat from the support ring (5, 6) to the anchoring box (7) and vice versa.

4. The compensator assembly as claimed in claim 1, wherein the support elements (16) are connected to at least one of the support ring (5, 6) or the anchoring box (7).

5. The compensator assembly as claimed in claim 1, wherein the support elements (16) comprise a thermally insulating material, or are formed from the thermally insulating material.

6. The compensator assembly as claimed in claim 1, wherein the support elements (16) are arranged in a uniformly distributed manner over a circumference of at least one of the support ring (5, 6) or the anchoring box (7).

7. The compensator assembly as claimed in claim 1, wherein a contact face between the support ring (5, 6) and the anchoring box (7) is reduced by the support elements (16) in comparison to a full-surface contact face (17) to less than 5% of said full-surface contact face (17).

8. The compensator assembly as claimed in claim 1, wherein an intermediate space, created by means of the support elements (16), between the support ring (5, 6) and the anchoring box (7) can be filled, or is filled, with a thermal insulating material.

9. The compensator assembly as claimed in claim 1, wherein the anchoring box (7) has a plurality of tie rods (10) which are arranged over a circumference of the anchoring box (7), and a center longitudinal axis of each of the tie rods (10) extends parallel to a center longitudinal axis of the compensator assembly (1) in a direction of the metal bellows (2).

10. The compensator assembly as claimed in claim 9, wherein there are twice as many of the support elements (16) as the tie rods (10).

11. The compensator assembly as claimed in claim 9, wherein the anchoring box (7) has two of the tie rods (10) which are connected to the anchoring box (7) at an angular distance of approximately 180°, and four of the support elements (16) are arranged at an angular distance of approximately 90° from each other.

12. The compensator assembly as claimed in claim 9, wherein the tie rods (10) have a flat upper side (10a) and a flat lower side (10b) which lie in parallel planes which are perpendicular to a plane (E1) which is spanned by the center longitudinal axis of the compensator assembly (1) and a center longitudinal axis of the tie rod (10).

13. The compensator assembly as claimed in claim 1, wherein each of the support elements (16) is arranged between two adjacent ones of the tie rods (10) and has an approximately equal angular distance from each of the two tie rods (10).

14. A support ring for a compensator assembly (1) as claimed in claim 1, wherein the support ring (5, 6), on at least one of the end faces (5a, 6a), includes the support elements (16) which project essentially perpendicularly from the end face (5a, 6a).

15. The support ring as claimed in claim 14, wherein the support ring is connected to one of the connecting ends (3, 4) of the metal bellows (2).

16. An anchoring box for a compensator assembly (1) of claim 1, wherein the anchoring box (7) includes the support elements (16) and a plurality of the tie rods (10) on at least one of the end faces (8a, 9a) thereof.

17. The compensator assembly as claimed in claim 1, wherein the support elements (16) are formed in one piece together with at least one of the support ring (5, 6) or with the anchoring box (7).
